(19) United States
(12) Patent Application Publication
(10) Pub. No.: US 2026/0361464 A1
(43) Pub. Date: Nov. 12, 2026

(54) METHOD FOR CONTROLLING DATA RETRANSMISSION IN APPLICATION LAYER, AND RELATED PRODUCT

(71) Applicant: Shanghai Cambricon Information Technology Co., Ltd, Shanghai (CN)

(72) Inventor: Yongzhe SUN, Shanghai (CN)

(21) Appl. No.: 19/131,875

(22) PCT Filed: Aug. 11, 2023
(86) PCT No.: PCT/CN2023/112582

§ 371 Date: May 21, 2025

(30) Foreign Application Priority Data
Nov. 25, 2022 (CN) 202211496930.1

(51) Int. Cl. H04L 1/1607; G06F 9/48

(52) U.S. Cl. CPC H04L 1/1607; G06F 9/4812

(57) ABSTRACT

The present disclosure provides a method for controlling data retransmission at an application layer and related products, where the method is included in a combined processing apparatus, and the combined processing apparatus further includes a general interconnection interface and other processing apparatus. A computing apparatus interacts with other processing apparatus to jointly complete a computing operation specified by a user. The combined processing apparatus further includes a storage apparatus. The storage apparatus is connected to the apparatus and other processing apparatus, respectively. The storage apparatus is configured to store data of the apparatus and other processing apparatus.

### CROSS REFERENCE TO RELATED APPLICATION

The present application is a 371 of international Application No.: PCT/CN2023/112582, filed Aug. 11, 2023 which claims priority to Chinese Patent Application No. 202211496930.1 with the title of “Method for Controlling Data Retransmission in Application Layer, and Related Product” filed on Nov. 25, 2022.

### TECHNICAL FIELD

The present disclosure relates to the field of chips and, more specifically, to the field of interchip communication.

### BACKGROUND

With the expansion of the scale of the neural network, the single-machine environment cannot better complete the training task independently. For example, the memory of the single machine is not enough to put down the entire neural network model, and the quantity of data is too large to load. In this case, it is usually necessary to introduce distributed training, in other words, multiple training devices work cooperatively and complete cooperative tasks as a whole system by communicating with each other.

However, the basis of distributed systems is communication, and communication needs to be built on the communication medium. Some communication media are reliable transmissions, such as socket, peripheral component interconnect express (PCIe), etc. The application layer only needs to send communication demands, and the transmission over the link is the reliable transmission. The reliable transmission means that the receiver application has received complete and correct data. However, there are also unreliable transmissions. For example, the IP protocol itself is an unreliable network layer transmission protocol. Specifically, after data is transmitted, there may be a packet loss, an error, and a response loss. How to carry out reliable transmissions over unreliable links is a problem that all communication has to face.

The current mainstream practice is to implement reliable communication protocols at the communication transport layer to complete reliable transmissions. A typical protocol is a transmission control protocol (TCP), which ensures transmission reliability through four main mechanisms: acknowledgement and serial number, timeout retransmission, traffic control, and congestion control. In other links, NVIDIA uses Nvlink to ensure reliable transmissions in the link layer and protocol layer. The patent application with the public number CN110278094 discloses a timeout retransmission apparatus based on link delay, to reduce the packet loss probability during aggregation link retransmission. The patent application with the public number CN112312513B, improves the performance of retransmission recovery in an apparatus configured for link failure recovery.

The applicant found that the above existing solution has the following technical defects:
1. a retransmission behavior occurs at a transport layer, and thus, more redundant information needs to be maintained at the transport layer to mark the location of the retransmission;
2. the transport layer requires an additional cache area to store the transmitted information for retransmission, which increases the consumption of storage resources;
3. during retransmission at the transport layer, because the application layer does not perceive this behavior, heavy traffic communication may still be required, which requires a traffic control unit for coordinated processing.

### SUMMARY

The purpose of the present disclosure is to solve the defects caused by retransmission at the transport layer in the prior art and to provide a solution for retransmission at the application layer.

A first aspect of the present disclosure provides a method for controlling data retransmission at an application layer, including: pre-transmitting data, where the data includes a payload and a count value for the payload; recording first transmitting end information in response to the data being in a pre-transmission state, where the first transmitting end information represents a first quantity of the data pre-transmitted; receiving and recording first receiving end information, where the first receiving end information represents a second quantity of the data received and fed back by a receiving end, where the second quantity does not exceed the first quantity; and determining whether to retransmit the data according to the first transmitting end information and the first receiving end information.

A second aspect of the present disclosure provides a device configured to control data retransmission at an application layer, including: a transmitting unit configured to pre-transmit data, where the data includes a payload and a count value for the payload; a transmitting end information update unit configured to record first transmitting end information in response to the data being in a pre-transmission state, where the first transmitting end information represents a first quantity of the data pre-transmitted; a receiving unit configured to receive and record first receiving end information, where the first receiving end information represents a second quantity of the data received and fed back by a receiving end, where the second quantity does not exceed the first quantity; and a retransmission judging unit configured to determine whether to retransmit the data according to the first transmitting end information and the first receiving end information.

A third aspect of the present disclosure provides a method for controlling data retransmission at an application layer in a communication system, where the communication system includes: a transmitting end, a receiving end, and a communication link connecting the transmitting end and the receiving end, and the method includes: at the transmitting end, pre-transmitting data to the receiving end, where the data includes a payload and a count value for the payload; recording first transmitting end information in response to the data being in a pre-transmission state, where the first transmitting end information represents a first quantity of the data pre-transmitted; transmitting the data through the communication link; at the receiving end, recording the count value if the data is received; generating a second quantity according to the count value, where the second quantity represents the quantity of the data received and fed back by the receiving end; feeding back the first receiving end information to the transmitting end, where the first receiving end information includes the second quantity, and the second quantity does not exceed the first quantity; at the transmitting end, receiving and recording the first receiving end information; and determining whether to retransmit the data according to the first transmitting end information and the first receiving end information.

A fourth aspect of the present disclosure provides a communication system configured to control data retransmission at an application layer, where the communication system includes: a transmitting end, a receiving end, and a communication link connecting the transmitting end and the receiving end, where the transmitting end pre-transmits data to the receiving end, where the data includes a payload and a count value for the payload; the transmitting end records first transmitting end information in response to the data being in a pre-transmission state, where the first transmitting end information represents a first quantity of the data pre-transmitted; the communication link is configured to transmit the data; the receiving end records the count value if the data is received; the receiving end generates a second quantity according to the count value, where the second quantity represents the quantity of the data received and fed back by the receiving end; the receiving end feeds back first receiving end information to the transmitting end, where the first receiving end information includes the second quantity, and the second quantity does not exceed the first quantity; the transmitting end receives and records the first receiving end information; and the transmitting end determines whether to retransmit the data according to the first transmitting end information and the first receiving end information.

A fifth aspect of the present disclosure provides an electronic device, including: one or a plurality of processors; and a memory, on which a computer-executable instruction is stored, which enables the electronic device to perform the method described above when the computer-executable instruction is run by the one or the plurality of processors.

A sixth aspect of the present disclosure provides a computer-readable storage medium, including a computer-executable instruction, where the method described above is performed when the computer-executable instruction is run by one or a plurality of processors.

The beneficial effects of the technical solution of the present disclosure include at least the following: the retransmission design at the software level at the application layer may reduce the hardware design at the transport layer, so the development is fast, and the hardware customization cost is low.

### BRIEF DESCRIPTION OF DRAWINGS

By reading the following detailed description with reference to drawings, the above-mentioned and other objects, features and technical effects of exemplary implementations of the present disclosure will become easier to understand. In the drawings, several implementations of the present disclosure are shown in an exemplary but not restrictive manner, and the same or corresponding reference numerals indicate the same or corresponding parts.

FIG. 1 shows a schematic diagram of a structure of a board card according to an embodiment of the present disclosure.

FIG. 2 shows a schematic diagram of a combined processing apparatus according to an embodiment of the present disclosure.

FIG. 3 shows a schematic diagram of an internal structure of a computing apparatus.

FIG. 4 shows an internal architecture of an intelligent processing unit (IPU) core.

FIG. 5 shows a schematic diagram of a communication system including a transmitting end and a receiving end according to an embodiment of the present disclosure.

FIG. 6 shows a method for controlling data retransmission at an application layer in a communication system according to an embodiment of the present disclosure.

FIG. 7 shows a schematic diagram of a normal communication process according to an embodiment of the present disclosure.

FIG. 8 shows a schematic diagram of a packet loss/error retransmission process.

FIG. 9 shows a situation where acknowledgment (ACK) fed back from a receiving end is lost.

FIG. 10 shows a flowchart of a method for controlling data retransmission at an application layer according to another aspect of the present disclosure.

FIG. 11 shows a device configured to control data retransmission at an application layer according to an aspect of the present disclosure.

### DETAILED DESCRIPTION

Technical solutions in embodiments of the present disclosure will be described clearly and completely hereinafter with reference to the drawings in the embodiments of the present disclosure. Obviously, the embodiments to be described are merely some rather than all examples of the present disclosure. All other embodiments obtained by those skilled in the art based on the embodiments of the present disclosure without creative efforts shall fall within the scope of protection of the present disclosure.

It should be understood that terms such as “first”, “second”, “third”, and “fourth” that appear in the claims, the specification, and the drawings are used for distinguishing different objects rather than describing a specific order. “First”, “second”, “third”, and “fourth” do not just mean one, but may also mean multiple. It should be understood that terms “including” and “comprising” used in the specification and the claims indicate the presence of a feature, an entity, a step, an operation, an element, and/or a component, but do not exclude the existence or addition of one or more of other features, entities, steps, operations, elements, components, and/or collections thereof.

It should also be understood that the terms used in the specification of the present disclosure are merely intended to describe a specific embodiment rather than to limit the present disclosure. As being used in the specification and the claims of the present disclosure, unless the context clearly indicates otherwise, singular forms such as “a”, “an”, and “the” are intended to include plural forms. It should also be understood that a term “and/or” used in the specification and the claims refers to any and all possible combinations of one or more of relevant listed items and includes these combinations.

As being used in the specification and the claims of the present disclosure, a term “if” may be interpreted as “when”, or “once” or “in response to a determination” or “in response to a case where something is detected” depending on the context. Similarly, depending on the context, a clause “if it is determined that” or “if [a described condition or event] is detected” may be interpreted as “once it is determined that”, or “in response to a determination”, or “once [a described condition or event] is detected”, or “in response to a case where [a described condition or event] is detected”.

Specific implementations of the present disclosure will be described in detail in combination with drawings below.

At present, a semiconductor manufacturing process starts with a complete wafer, which is a round slice composed of pure silicon, generally divided into 6 inches, 8 inches, 12 inches and other specifications. The wafer is cut into small pieces. This small piece is called a die. Each die is fitted with a chip and wired to achieve a specific electrical function. Then the die is packaged into a particle, the purpose of the package is to install, fix, seal, protect the chip and enhance the electric heating performance, and at the same time, the contact of the chip is connected to the pin of the package shell with a wire. At this point, a chip packaging structure is completed.

A memory is configured to temporarily store operation data required by a system on chip (SoC), as well as data exchanged with an external memory. In this embodiment, the memory may be a high bandwidth memory (HBM), which is a high-performance dynamic random access memory (DRAM) based on 3D stack process and is suitable for applications with high memory bandwidth requirements, such as graphics processing units, and network switching and forwarding devices (such as routers and switches).

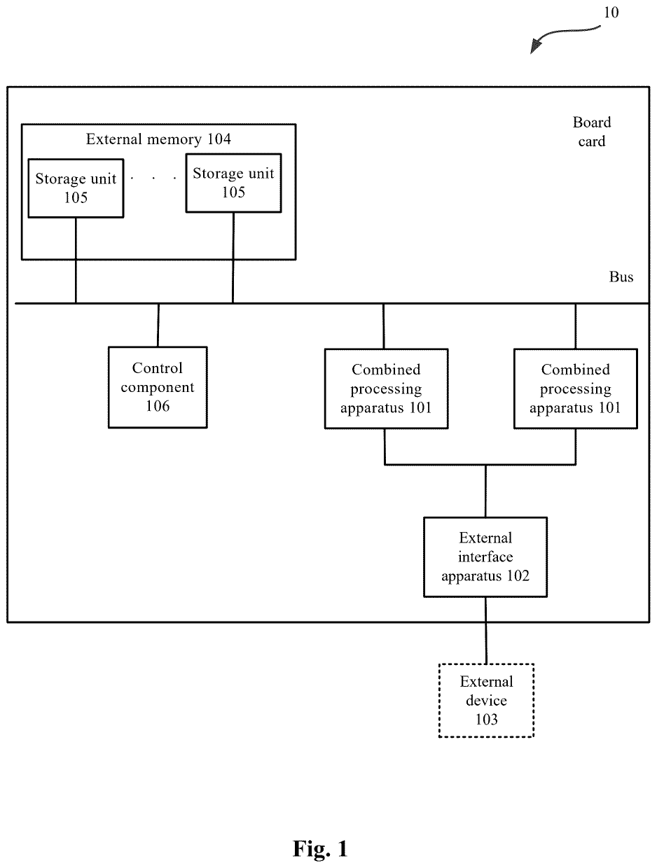

The SoC refers to the technology of integrating a complete system on a single chip and performing packet grouping on all or part of necessary electronic circuits. In this embodiment, the SoC is mounted on the board card. FIG. 1 is a structural diagram of a board card 10 according to an embodiment of the present disclosure. As shown in FIG. 1, the board card 10 includes a combined processing apparatus 101, which is an artificial intelligence operation unit configured to support various deep learning and machine learning algorithms and meet the intelligent processing requirements in complex scenarios in computer vision, speech, natural language processing, data mining, and other fields. In particular, deep learning technology is widely applied in the field of cloud intelligence. A prominent feature of cloud intelligence applications is a large quantity of input data, which has high requirements for storage capacity and computing power of a platform. The board card 10 of this embodiment is suitable for cloud intelligent applications and has huge off-chip storage, huge on-chip storage, and a large quantity of computing power.

The combined processing apparatus 101 is connected to an external device 103 through an external interface apparatus 102. The external device 103 may be, for example, a server, a computer, a camera, a monitor, a mouse, a keyboard, a network card, or a WIFI interface. To-be-processed data may be transferred to the combined processing apparatus 101 from the external device 103 through the external interface apparatus 102. Computing results of the combined processing apparatus 101 may be transferred back to the external device 103 via the external interface apparatus 102. According to different application scenarios, the external interface apparatus 102 may have different interface forms such as a standard peripheral component interface express (PCIe) interface, and the like.

The board card 10 further includes an external memory 104 configured to store data. The external memory 104 includes one or more storage units 105. The external memory 104 is connected to and transfers data with a control component 106 and the combined processing apparatus 101 through a bus. The control component 106 in the board card 10 is configured to regulate and control a state of the combined processing apparatus 101. As such, in an application scenario, the control component 106 may include a micro controller unit (MCU).

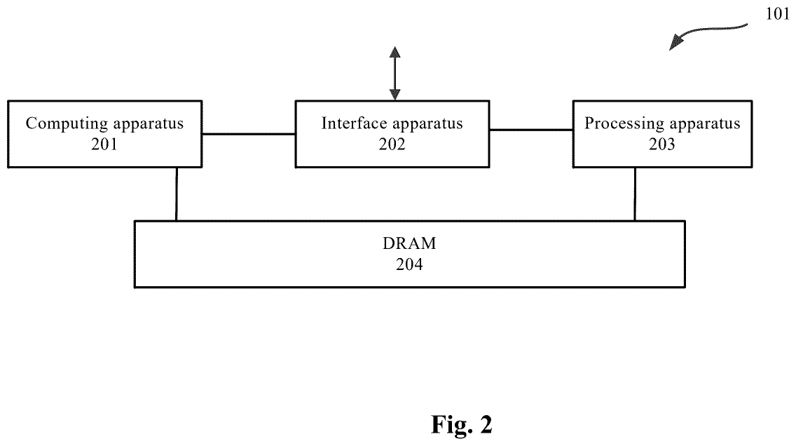

FIG. 2 is a schematic diagram of the combined processing apparatus 101 in this embodiment. As shown in FIG. 2, the combined processing apparatus 101 includes a computing apparatus 201, an interface apparatus 202, a processing apparatus 203, and a DRAM 204. In an application scenario, the computing apparatus 201, the interface apparatus 202, and the processing apparatus 203 are integrated into the aforementioned system on chip. In another application scenario, the computing apparatus 201 itself is the aforementioned system on chip.

The computing apparatus 201 is configured to perform an operation specified by a user. The computing apparatus 201 is mainly implemented as a single-core intelligent processor or a multi-core intelligent processor. The computing apparatus 201 is used for performing deep learning computing or machine learning computing. The computing apparatus 201 interacts with the processing apparatus 203 through the interface apparatus 202 to jointly complete the operation specified by the user.

The interface apparatus 202 is configured to transfer data and control instructions between the computing apparatus 201 and the processing apparatus 203. For example, the computing apparatus 201 may obtain input data from the processing apparatus 203 via the interface apparatus 202 and write it into an on-chip storage apparatus of the computing apparatus 201. Further, the computing apparatus 201 may obtain control instructions from the processing apparatus 203 via the interface apparatus 202 and write them into an on-chip control cache of the computing apparatus 201. Alternatively or optionally, the interface apparatus 202 may also read data in the storage apparatus of the computing apparatus 201 and transfer it to the processing apparatus 203.

The processing apparatus 203 serves as a general processing apparatus and performs basic controls including, but not limited to, moving data, starting and/or stopping the computing apparatus 201. Depending on implementations, the processing apparatus 203 may be one or more types of a central processing unit (CPU), a graphics processing unit (GPU), or other general-purpose and/or special-purpose processors. These processors include, but are not limited to, a digital signal processors (DSP), an application specific integrated circuits (ASIC), a field-programmable gate arrays (FPGA) or others programmable logic components, discrete gate or transistor logic components, discrete hardware components, etc., and their number may be determined according to actual needs. As mentioned above, only as far as the computing apparatus 201 of the present disclosure is concerned, it may be regarded as having a single-core structure or a homogeneous multi-core structure. However, when considered together, the computing apparatus 201 and the processing apparatus 203 are viewed as forming a heterogeneous multi-core structure.

The DRAM 204 is the aforementioned high bandwidth memory configured to store to-be-processed data, usually 16 GB or larger. The DRAM 204 is configured to store data of the computing apparatus 201 and/or the processing apparatus 203.

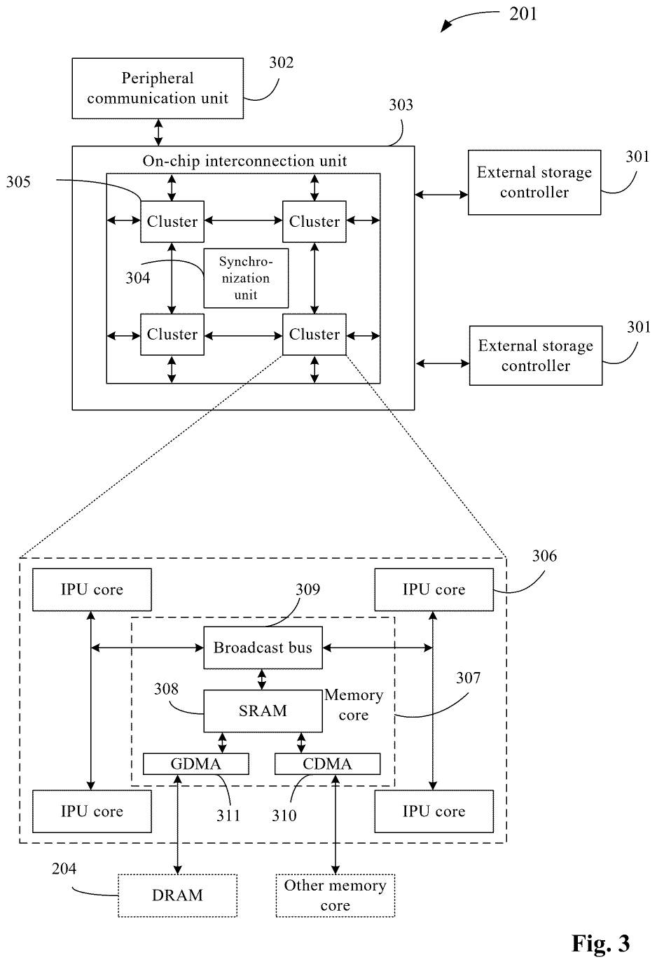

FIG. 3 is a schematic diagram of an internal structure of the computing apparatus 201. The computing apparatus 201 is configured to process input data in computer vision, speech, natural language, and data mining. The computing apparatus 201 in the figure is designed with a multi-core hierarchical structure and includes an external storage controller 301, a peripheral communication unit 302, an on-chip interconnection unit 303, a synchronization unit 304, and a plurality of clusters 305.

There may be a plurality of external storage controllers 301, two of which are illustrated in the figure. The external storage controllers are configured to, in response to access requests from processor cores, access an external storage device, such as the DRAM 204 in FIG. 2, thereby reading data from off-chip or writing the data to off-chip. The peripheral communication unit 302 is configured to receive a control signal from the processing apparatus 203 through the interface apparatus 202 to start the computing apparatus 201 to perform a task. The on-chip interconnection unit 303 connects the external storage controller 301, the peripheral communication unit 302, and the plurality of clusters 305 and is configured to transfer data and control signals among the units. The synchronization unit 304 is a global barrier controller (GBC) and is configured to coordinate a work progress of each cluster to ensure synchronization of information. The plurality of clusters 305 are computing cores of the computing apparatus 201, four of which are illustrated in the figure. With the development of hardware, the computing apparatus 201 of the present disclosure may further include 8, 16, 64, or even more clusters 305. The clusters 305 are used for efficiently performing deep learning algorithms.

Each cluster 305 includes a plurality of intelligent processing unit (IPU) cores 306 and a memory core (MEM core) 307.

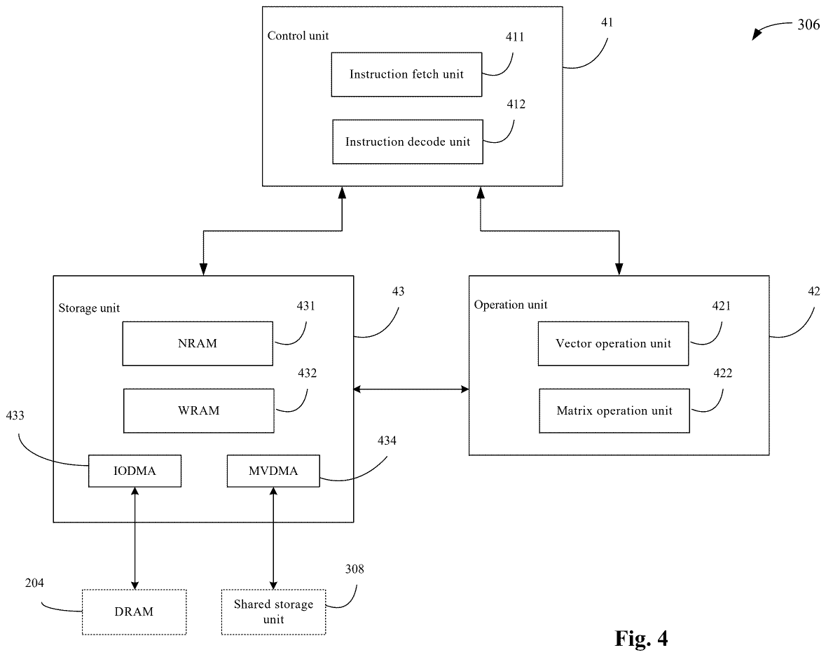

Four IPU cores 306 are illustrated in the figure. The present disclosure does not limit the number of the IPU cores 306. An internal architecture of the IPU core 1006 is shown in FIG. 4. Each IPU core 306 includes three units: a control unit 41, an operation unit 42, and a storage unit 43.

The control unit 41 is configured to coordinate and control work of the operation unit 42 and the storage unit 43 to complete a deep learning task. The control unit 41 includes an instruction fetch unit (IFU) 411 and an instruction decode unit (IDU) 412. The IFU 411 is configured to obtain an instruction from the processing apparatus 203. The IDU 412 is configured to decode the instruction obtained and transmit a decoding result as control information to the operation unit 42 and the storage unit 43.

The operation unit 42 includes a vector operation unit 421 and a matrix operation unit 422. The vector operation unit 421 is used for performing a vector operation and supports complex operations, such as vector multiplication, vector addition, and vector nonlinear conversion. The matrix operation unit 422 is responsible for core computing of deep learning algorithms, which includes matrix multiplication and convolution.

The storage unit 43 is configured to store or move related data. The storage unit 43 includes a neuron random access memory (NRAM) 431, a weight RAM (WRAM) 432, an input/output direct memory access (IODMA) 433, and a move direct memory access (MVDMA) 434. The NRAM 431 is configured to store input and output data and intermediate results for computing by the IPU cores 306 calculations. The WRAM 432 is configured to store a weight of a deep learning network. The IODMA 433 controls memory accesses of the NRAM 431/the WRAM 432 and the DRAM 204 through a broadcast bus 309. The MVDMA 434 is configured to control memory accesses of the NRAM 431/the WRAM 432 and a shared storage unit (SRAM) 308.

Going back to FIG. 3, the memory core 307 is mainly used for storage and communication. In other words, the memory core 307 is mainly used for storing shared data or intermediate results between the IPU cores 306 and performing communications between the clusters 305 and the DRAM 204, communications between the clusters 305, and communications between the IPU cores 306. In other embodiments, the memory core 307 is capable of performing a scalar operation and is configured to perform the scalar operation.

The memory core 307 includes the SRAM 308, the broadcast bus 309, a cluster direct memory access (CDMA) 310, and a global direct memory access (GDMA) 311. The SRAM 308 plays the role of a high-performance data transfer station. Data reused among different IPU cores 306 in the same cluster 305 is not required to be obtained from the DRAM 204 separately through the IPU cores 306. Instead, the data is transferred among the IPU cores 306 through the SRAM 308. The memory core 307 is only required to quickly distribute the reused data from the SRAM 308 to the plurality of IPU cores 306 to improve inter-core communication efficiency and greatly decrease on-chip/off-chip input/output access.

The broadcast bus 309, the CDMA 310, and the GDMA 311 are used for performing the communication between the IPU cores 306, the communication between the clusters 305, and data transmission between the clusters 305 and the DRAM 204, respectively. The above will be explained separately below.

The broadcast bus 309 is used for completing high-speed communication between the IPU cores 306 in the clusters 305. The broadcast bus 309 of this embodiment supports inter-core communication modes including unicast, multicast, and broadcast. The unicast refers to point-to-point (single IPU core-to-single IPU core) data transmission. The multicast refers to a communication mode for transferring one copy of data from the SRAM 308 to a certain number of IPU cores 306. The broadcast refers to a communication mode for transferring one copy of data from the SRAM 308 to all IPU cores 306. The broadcast is a special case of the multicast.

The CDMA 310 is configured to control memory access of the SRAM 308 among different clusters 305 in the same computing apparatus 201. The GDMA 311 works with the external storage controller 301 to control memory access from the SRAM 308 to the DRAM 204 in the clusters 305 or read data from the DRAM 204 to the SRAM 308.

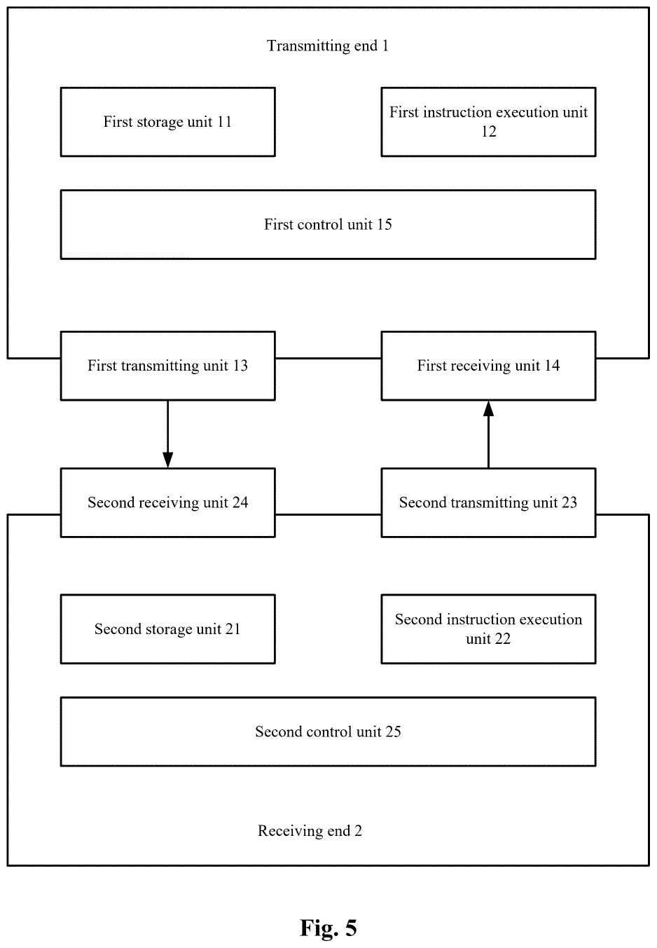

FIG. 5 is a schematic diagram of a communication system including a transmitting end and a receiving end according to an embodiment of the present disclosure.

The communication system may be divided in components according to functions, including a transmitting end 1 and a receiving end 2. The transmitting end 1 may include a first storage unit 11, a first instruction execution unit 12, a first transmitting unit 13, a first receiving unit 14, and a first control unit 15; and the receiving end 2 includes a second storage unit 21, a second instruction execution unit 22, a second transmitting unit 23, a second receiving unit 24, and a second control unit 25.

For the transmitting end 1, functions of the units are as follows.

The first storage unit 11 is configured to store data and instructions. The data may be original local data, or data transmitted from an upstream device (during multi-level transmission), or result data of the computation of the data transmitted from the upstream device and the local data.

The first instruction execution unit 12 is configured to execute the instructions in the first storage unit 11 and is responsible for the execution of application layer logic. In this communication system, a transmitting request is initiated by an instruction, in other words, a communication behavior is initiated by an application layer. In addition, the first instruction execution unit 12 may also perform local operations according to instructions.

The first transmitting unit 13: the transmitting end 1 is directly connected to a physical link through the first transmitting unit 13. The first transmitting unit 13 is configured to transmit data and control information. The first transmitting unit 13 may count communication packets transmitted and receive the response of each packet. If negative acknowledgment (NACK, meaning an abnormal response) is received or no acknowledgement (ACK, meaning a positive feedback, indicating that the receiving end has correctly received a corresponding packet) is received for long time, this abnormal state is recorded, and an interruption is reported to the first control unit 15. If an ACK is received within the specified time, an ACK is returned to this ACK again.

The first receiving unit 14: the transmitting end is directly connected to a physical link through the first receiving unit 14. The first receiving unit 14 is only configured to receive control information on the transmitting end 1.

The first control unit 15 is configured to deliver a task, receive an interruption of the first transmitting unit 13, suspend the operation of the first instruction execution unit 12, and re-deliver the task to the first instruction execution unit 12 for retransmission.

For the receiving end 2, functions of the units are as follows.

The second storage unit 21 is configured to store data and instructions. The data may be original local data, or data transmitted from an upstream transmitting end, or result data of the computation of the data transmitted from the upstream transmitting end and the local data.

The second instruction execution unit 22 is configured to execute the instructions in the second storage unit 21 and is responsible for the execution of application layer logic. In this communication system, a transmitting request is initiated by an instruction, in other words, a communication behavior is initiated by an application layer. In addition, the second instruction execution unit 22 may also complete local operations according to instructions.

The second receiving unit 24: the receiving end 2 is directly connected to a physical link through the second receiving unit 24. The second receiving unit 24 receives the received data packet and completes memory synchronization operations according to the type of the data packet. Verification and error correction are performed on the received packet. If the error cannot be corrected, an NACK is returned to the transmitting unit at the transmitting end. An ACK is returned for the correct receiving of each packet. If the ACK transmitted by the second receiving unit 24 is not answered by an ACK, this abnormal state is recorded, and an interruption is reported to the second control unit 25.

The second transmitting unit 23: the receiving end is directly connected to a physical link through the second receiving unit 23. The second transmitting unit 23 is only configured to transmit control information at the receiving end.

The second control unit 25 is configured to deliver a task, suspend the operation of the second instruction execution unit 22 according to the interruption transmitted by the second receiving unit 24, and re-deliver the task to the second instruction execution unit 22 for retransmission.

The following describes in detail the specifications of the application layer when performing data transmitting tasks.

When the transmitting tasks are performed on the application layer, data and control information need to be transmitted explicitly. The control information at the transmitting end 1 means the number of data fragments that have been transmitted by the transmitting end 1; and the control information on the receiving end 2 means the number of data fragments that have been processed by the receiving end 2.

According to a data structure of a queue, the control information at the transmitting end may be recorded as Tail, and the control information on the receiving end 2 may be recorded as Head. It should be noted that having received the data by the receiving end 2 and having processed the data by the receiving end 2 are two concepts. Even if the receiving end 2 only receives data, if the transmitting end 1 does not transmit the data directly to a destination storage space (denoted Dstspace) of the receiving end 2, but to a receiving buffer (denoted Recvbuffer) of the receiving end 2, then the receiving end 2 also needs to copy the data from the Recvbuffer to the Dstspace. Only after the receiving end 2 confirms that the data is in the Dstspace will the value of Head be updated. Recvbuffer is a function name for a cache hardware storage space at the receiving end.

Therefore, Head and Tail are required to meet the following constraints.
1. When no data is retransmitted, both the Head and Tail increase monotonically. Each increment is the number of data fragments that are transmitted or received this time.
2. At any given time, Head does not exceed Tail.
3. If the data transmitted from the transmitting end 1 to the receiving end 2 is written to the Recvbuffer, the difference between Head and Tail should not exceed half of the Recvbuffer size. Assuming that the overall capacity of the Recvbuffer of the receiving end is expressed as m, a maximum of m data fragments with the size of the difference between tail and head are allowed. Then it may be assumed that two devices A and B will execute a communication algorithm, which is an Allreduce algorithm. The two devices A and B first transmit X pieces of their own data to each other, and then obtain X pieces of upstream data from the Recvbuffer and complete the computation with local data, and then transmit X pieces of data to each other again. Here, the first constraint is that X must be less than M, because if X is greater than M, the data will be out of bounds. Then, if X=M, if each device performs the second step, which is “acquiring X pieces of upstream data from the Recvbuffer and completing the computation with local data, and transmitting X pieces of data to each other again”, it is found that the Recvbuffer of the other party has been fully occupied by the first step, in other words, “transmitting X pieces of their own data to each other”, so the second step may not be performed, so that neither device may enter the second stage, and a deadlock is formed. Therefore, on the constraint of X<M, after performance testing, X=½m is the optimal value, so that the transmitting and processing may be balanced.
4. The transmitting destination addresses of the Head and Tail remain unchanged. The Head and Tail that are transmitted later overwrite the original values on the device storage space. In other words, it is not allowed to have multiple Head values or multiple Tail values, but a previous Head value is overwritten by a new Head value, or a previous Tail value is overwritten by a new Tail value.
5. Both the Head and Tail have memory synchronization semantics. When each Head/Tail is written into the device memory, Data, Head, and Tail transmitted by the same physical link before this Head/Tail must be written into the device storage space. Devices here, in the present disclosure, usually refer to hardware of the transmitting device and the receiving device.

Under unreliable links, the following three types of errors may occur.
1. Data packets are lost or errors occur during the transmitting process. The lost data packets here may be the loss of payload data, or the loss of the transmitted Tail, or an error in the payload data or the Tail. In this case, a packet sequence number error (PSN Error) of the link will be triggered. When the PSN verification at the receiving end fails, an NACK will be returned to the transmitting end. In addition, in this case, a timeout mechanism may also be triggered to actively end the communication.
2. If an error code is generated during the transmitting process and cannot be corrected by the error correction at the receiving end, the receiving end will feed back an NACK to the transmitting end at this time.
3. The transmitting process is all normal, but an ACK returned by the receiving end is lost. In this case, the transmitting end will still trigger a timeout mechanism.

When the above three situations occur, by retransmitting from an exception position, the retransmission may succeed or fail. Only when correct communication still cannot be completed after repeated retransmissions (for example, three consecutive times), will it be considered that an exception that cannot be retransmitted has occurred. In this case, it is usually necessary for the application to completely stop data transmission to check whether there are any exceptions in the link.

To handle the above three situations that retransmission may be performed, the exception handling methods executed at the application layer need to have the following key points.
1. Since exceptions occurring on the link are low-probability events, the exception handling logic at the application layer should have less interference with the normal application layer task logic.
2. Also, since the occurrence of exceptions is a low-probability event, when an exception occurs and retransmission is carried out, the functional correctness of the retransmission algorithm is given priority, and the performance requirements are relatively reduced. In other words, the priority is to ensure the correctness of the retransmission, and the performance requirements during the execution of the retransmission algorithm is not the priority.
3. During the retransmission at the application layer, redundant retransmission is allowed, in other words, the retransmitted content is more than the actual lost/erroneous content.
4. During the retransmission at the application layer, even though there may be more redundancy in the retransmission at the transmitting end, the receiving end should only process packets starting from the error location. This is because the receiving end may have performed an in-Place operation. At this point, the computation result has covered the original local data area. If the computation is performed again, the result of the application task will be wrong, so it is not allowed.
5. Since Head/Tail communicates by overwriting, the devices (the transmitting end and the receiving end) need to back up the values of Head/Tail, which may be called a checkpoint. Subsequent retransmission and recovery should start from the checkpoint. Therefore, each device should also record the previously transmitted location information locally. For subsequent retransmission and recovery, the previously transmitted location should be taken as the destination of the retransmission.

After introducing the above specifications and constraints, the following details a method for controlling data retransmission at an application layer in a communication system according to an embodiment of the present disclosure.

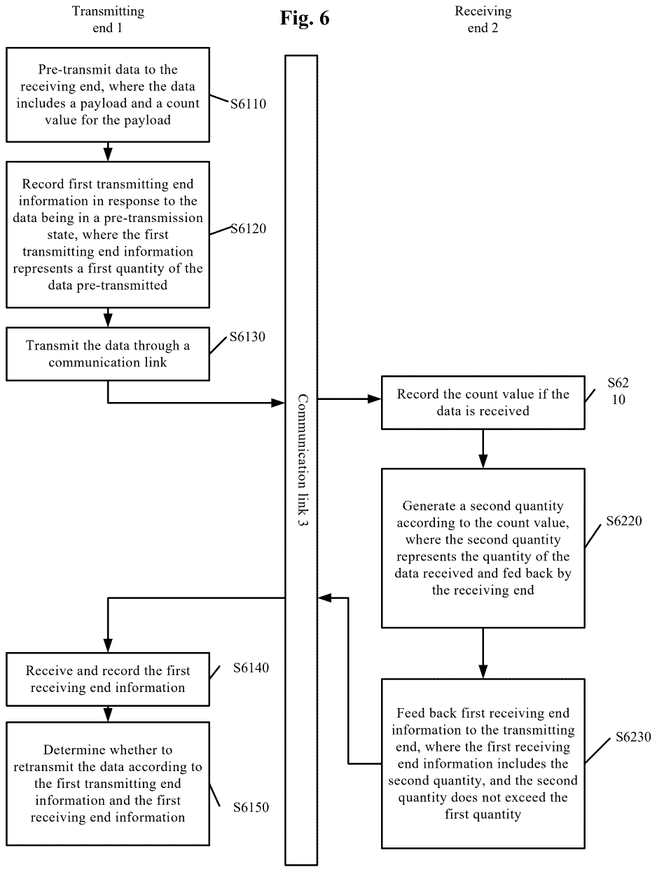

FIG. 6 shows a method for controlling data retransmission at an application layer in a communication system according to an embodiment of the present disclosure, where the communication system includes: a transmitting end 1, a receiving end 2, and a communication link 3 connecting the transmitting end 1 and the receiving end 2, and the method includes: at the transmitting end 1, in step S6110, pre-transmitting data to the receiving end 2, where the data includes a payload and a count value for the payload; in step S6120, recording first transmitting end information in response to the data being in a pre-transmission state, where the first transmitting end information represents a first quantity of the data pre-transmitted; in step S6130, transmitting the data through the communication link; at the receiving end 2, in step S6210, recording the count value if the data is received; in step S6220, generating a second quantity according to the count value, where the second quantity represents the quantity of the data received and fed back by the receiving end; in step S6230, feeding back the first receiving end information to the transmitting end, where the first receiving end information includes the second quantity, and the second quantity does not exceed the first quantity; at the transmitting end 1, in step S6140, receiving and recording the first receiving end information; and in step S6150, determining whether to retransmit the data according to the first transmitting end information and the first receiving end information.

The above embodiments of the present disclosure are explained below in conjunction with a series of accompanying drawings.

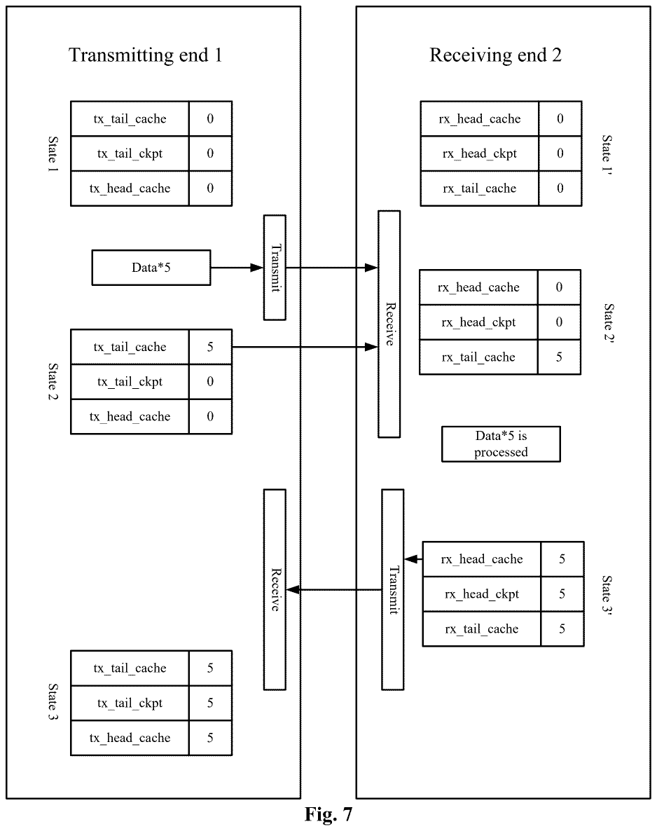

FIG. 7 is a schematic diagram of a normal communication process according to an embodiment of the present disclosure. In FIG. 7, data is assumed to be transmitted from a transmitting end 1 to a receiving end 2. For ease of description, a first transmitting unit 13 at the transmitting end 1 is labeled tx, and a second receiving unit 24 at the receiving end 2 is labeled rx. The Head/Tail communication address is marked as ptr, the Head/Tail checkpoint is marked as ckpt, and the maximum number that has been currently transmitted by Head/Tail is marked as cache. According to an embodiment of the present disclosure, the following key variables may be built.
1. tx_tail, which is tail information transmitted by the transmitting end 1. The tail information has already been introduced in the previous section and will not be repeated here.
2. tx_tail_cache, which is tx_tail that has been transmitted by the transmitting end 1, but has not yet been acknowledged as received by the receiving end 2, where the tx_tail may be stored in the storage space of the transmitting end 1 for transmission (for example, Recybuffer, which is the cache of the transmitting end 1). The tx_tail_cache may indicate that the transmitting end 1 “thought it had been transmitted but might not have actually been transmitted to the receiving end 2. In the present disclosure, data that has been transmitted by the transmitting end 1 but may not actually have been transmitted to the receiving end 2 may be referred to as pre-transmitted data. The pre-transmitted data may include a payload and a count value for the payload, where the count value is the tail information described above. When the transmitting end 1 has pre-transmitted the data, regardless of whether the data is transmitted successfully or not, the above tx_tail_cache may be updated (in other words, first transmitting end information is updated in response to the data being in a pre-transmission state).

According to an embodiment of the present disclosure, recording first transmitting end information in response to the data being in a pre-transmission state may include: incrementing a first quantity accordingly in response to the increment of the data in the pre-transmission state, regardless of whether the data is transmitted successfully, and/or whether or not a response to the data is received.

In this embodiment, every time a piece of data enters a “pre-transmission” state, a tail value carried by the data is increased once. The increment of the tail value does not consider whether the data is actually transmitted successfully, nor does it consider whether the transmitting end 1 receives the response value (for example, the head) for the data.

It should be understood that in the present disclosure, the first transmitting end information may be recorded whenever the first transmitting end information is updated, or the first transmitting end information with the maximum value may be directly recorded. For example, the transmitting end may poll the maximum value of the current tail at intervals. In this case, it is possible to poll directly to the maximum tail value or some of the tail values, without necessarily polling to the tail value corresponding to the currently transmitted data.
3. tx_tail_ckpt, which is tx_tail that has been transmitted by the transmitting end 1 and has been acknowledged as received by the receiving end 2. It generally means that the receiving end 2 acknowledges by replying to the head. If the receiving end 2 acknowledges through the head method, it indicates that the receiving end has received the data sent by the transmitting end 1. The breakpoint during data retransmission may be determined through the tx_tail_ckpt.
4. rx_head, which is head information transmitted from the receiving end 2 to the transmitting end 1. When the receiving end 2 receives data containing tail, the tail value (the count value described above) is recorded. The receiving end 2 may acknowledge that the data has been received by replying or feeding back the head value to the transmitting end 1, in other words, the head value may reflect the quantity of data (for example, tail) received by the receiving end 2.

As the receiving end 2 receives and processes the data, the head value increases accordingly. But the head value is less than or equal to the tail value received. For example, if data with tail values ranging from 1 to 3 all reached the receiving end 2 smoothly, each time the receiving end 2 receives and processes one tail value, the head value is updated accordingly, in other words, the head value is equal to the tail value. However, if data with a tail value of 4 is blocked, in other words, no data with a tail value of 4 is received at the receiving end 2, the maximum head value generated at the receiving end 2 is 3.
5. rx_head_cache, which is rx_head that has been transmitted by the receiving end 2 but has not yet been acknowledged as received by the transmitting end 1. Generally speaking, the transmission of the rx_head does not require additional acknowledgement from the receiving end 1, as long as no timeout occurs, it is considered to have been delivered. In the present disclosure, the rx_head_cache may be used to represent first receiving end information; in other words, the rx_head_cache may be used to represent a second quantity of the data received and fed back by the receiving end 2.
6. rx_head_ckpt, which is rx_head that has been transmitted by the receiving end 2 and has been acknowledged as received by the receiving end 1.
7. rx_tail_cache, which is tail value received by the receiving end 2 when accessing dram to check tail this time, in other words, the tail value actually received by the receiving end 2.

According to an embodiment of the present disclosure, recording the count value if the data is received includes: overwriting an old count value with a new count value.

According to this embodiment, the receiving end 2 may record each received tail value and overwrite the previous tail value with the latest tail value, so that the receiving end 2 will keep the tail value at its maximum.

According to an embodiment of the present disclosure, recording the count value if the data is received includes: searching for a maximum count value in the received data; and recording the maximum count value only.

According to an embodiment of the present disclosure, the receiving end 2 may poll for the maximum value of the received tails at regular intervals. In this case, it is possible to poll directly to the maximum tail value or some of the tail values, without necessarily polling for the tail value corresponding to the currently transmitted data. In these cases, the maximum tail value may be recorded directly, without the need to record other tail values. In this way, only the maximum tail value needs to be focused on, without the need to record all tail values.
8. tx_head_cache, which is head value received by the transmitting end 1 when accessing dram to check head this time, in other words, the head value actually transmitted by the receiving end 2 and actually received by the transmitting end 1.

As shown in FIG. 7, a first state table that records states of parameters may be stored at the transmitting end 1. The first state table may contain at least three parameters, for example, tx_tail_cache, tx_tail_ckpt, and tx_head_cache. In an initial state, values of these parameters are all 0, as shown in a state 1 in FIG. 7.

Similarly, a second state table that records states of parameters may be stored at the receiving end 2. The second state table may contain at least three parameters, for example, rx_head_cache, rx_head_ckpt, and rx_tail_cache. In an initial state, values of these parameters are all 0, as shown in a state 1′ in FIG. 7.

Next, assuming that the transmitting end 1 transmits 5 pieces of data to the receiving end 2, then the value of the tx_tail_cache changes to 5, which means that the transmitting end 1 has transmitted 5 pieces of data, but whether the 5 pieces of data reaches the receiving end 2 has not been acknowledged. When transmitting the data, the transmitting end 1 also transmits the tail of each data to the receiving end. Each time a piece of data is transmitted, the tail value increments. This is as shown in a state 2 in FIG. 7.

At the receiving end 2, when data is received, it may be recorded as rx_tail_cache. The rx_tail_cache increases as the tail value increases. After 5 pieces of data are received, the value of the rx_tail_cache is updated to 5. The rx_tail_cache may also directly record and reflect the maximum value of the received tail instead of increasing gradually. This is as shown in a state 2′ in FIG. 7.

After processing the data, the receiving end 2 feeds back the head value to the transmitting end 1, but whether the transmitting end 1 receives the head value is unknown. In this case, the state of the rx_head_cache is updated to 5, which means that the receiving end 2 has transmitted 5 pieces of head information (rx_head), but the 5 pieces of head information have not yet acknowledged as received by the transmitting end 1.

After receiving the head information, the transmitting end 1 transmits a feedback signal to the receiving end 2. After the receiving end 2 receives the feedback signal, the rx_head_ckpt is updated. As shown in a state 3′ in FIG. 7, the rx_head_ckpt is updated to 5.

As shown in a state 3 in FIG. 7, the value of the rx head_cache may be fed back to the transmitting end 1, so that the tx_head_cache is updated to 5.

Further, as shown in the state 3 in FIG. 7, returning to the transmitting end 1, the tx_tail_ckpt is also updated to 5, which indicates the number of tx tails that have been acknowledged by the receiving end 2 after the transmitting end 1 has transmitted 5 pieces of data, as shown in the state 3 in FIG. 7.

As can be seen from FIG. 7, by checking the tx_tail_cache, tx_tail_ckpt, and tx_head_cache at the transmitting end 1, and the rx_head_cache, rx_head_ckpt, and rx_tail_cache at the receiving end 2, the transmitting and receiving of data, the transmitting and receiving of tail and head values, and the breakpoint may be understood.

What happens when data is transmitted normally has been described in combination with FIG. 7, and the following is a detailed description of what happens when a data transmission error occurs, in conjunction with other accompanying diagrams.

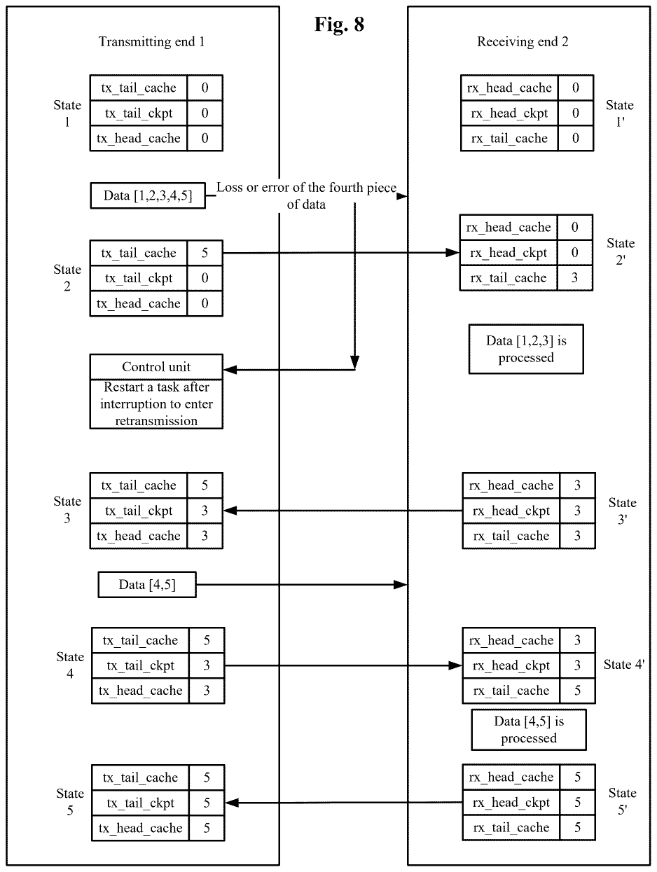

FIG. 8 is a schematic diagram of a packet loss/error retransmission process. It should be understood that, for the sake of simplification, in FIG. 8, only the transmitting and receiving directions of data are shown, and transmitting and receiving units are not shown.

As shown in FIG. 8, a first state table that records states of parameters may be stored at the transmitting end 1. The first state table may contain at least three parameters, for example, tx_tail_cache, tx_tail_ckpt, and tx_head_cache. In an initial state, values of these parameters are all 0, as shown in a state 1 in FIG. 8.

Similarly, a second state table that records states of parameters may be stored at the receiving end 2. The second state table may contain at least three parameters, for example, rx_head_cache, rx_head_ckpt, and rx_tail_cache. In an initial state, values of these parameters are all 0, as shown in a state 1′ in FIG. 8.

Next, assuming that the transmitting end 1 transmits 5 pieces of data to the receiving end 2, for example, data [1,2,3,4,5], then the value of the tx_tail_cache changes to 5, which means that the transmitting end 1 has transmitted 5 pieces of data, but whether the 5 pieces of data reaches the receiving end 2 has not been acknowledged. Meanwhile, when transmitting data, the transmitting end 1 also transmits the tail of each data to the receiving end. Each time a piece of data is transmitted, the tail value increments. This is as shown in a state 2 in FIG. 8.

At the receiving end 2, when data is received, the rx_tail_cache increases as the tail value increases. Unlike the embodiment shown in FIG. 7, in the embodiment of the present disclosure, a data loss or error occurs starting from the fourth data; in other words, only data [1,2,3] are successfully transmitted to the receiving end 2. Therefore, the value of the rx tail cache is updated to 3. This is as shown in a state 2′ in FIG. 8.

Since data is lost or an error occurs during transmission, a link may send an interruption request to the transmitting end 1. The control unit at the transmitting end 1 may determine what causes the reported interruption, and then decide whether to retransmit based on the specific cause of the interruption.

After receiving the data [1,2,3], the receiving end 2 transmits the head information back to the transmitting end 1, but it is not known whether the transmitting end 1 receives the head value. Since only 3 pieces of data are received at the receiving end 2, the receiving end 2 transmits information with head 1-3. In this case, the state of the rx_head_cache is updated to 3, which means that the receiving end 2 has transmitted 3 pieces of head information (rx_head), but the 3 pieces of head information have not yet acknowledged as received by the transmitting end 2. This is as shown in a state 3′ in FIG. 8.

After receiving the head information, the transmitting end 1 transmits a feedback signal to the receiving end 2. After the receiving end 2 receives the feedback signal, the rx_head_ckpt is updated. As shown in the state 3′ in FIG. 8, since the receiving end receives only 3 pieces of data, and the head value fed back by the receiving end is 1-3, the rx_head_ckpt is updated to 3.

Returning to the transmitting end 1, the receiving end 2 feeds back the rx head cache to the transmitting end 1. After receiving the feedback, the transmitting end 1 updates the tx_head_cache to 3, which means that after the transmitting end 1 has transmitted 5 pieces of data, the receiving end 2 acknowledges the receiving and feeds back 3 pieces of data through the head, as shown in the state 3 in FIG. 8.

Further, as shown in the state 3 in FIG. 8, the tx_tail_ckpt is correspondingly updated to 3, indicating that the retransmission should start with the fourth data.

According to an embodiment of the present disclosure, in response to an interruption signal reported from a communication link, whether to retransmit the data is determined according to the first transmitting end information and the first receiving end information.

As mentioned above, if the communication link reports the interruption signal, there may be several interruption types, some of which require retransmission of data, while others do not require retransmission of data. According to an embodiment of the present disclosure, determining whether to retransmit the data according to the first transmitting end information and the first receiving end information includes: determining a type of an interruption according to the first transmitting end information and the first receiving end information; and determining whether to retransmit the data according to the type of the interruption.

According to an embodiment of the present disclosure, determining the type of the interruption according to the first transmitting end information and the first receiving end information includes: determining the type of the interruption as a data loss or error from the transmitting end to the receiving end if the first quantity is greater than the second quantity. According to an embodiment of the present disclosure, the data loss or error from the transmitting end to the receiving end includes a loss of a payload and/or a loss or error of a count value. It should be understood that the data loss here is not only the loss of the payload data, but also may involve the loss of other information such as tail values. For example, even if the payload data is correctly transmitted from the transmitting end 1 to the receiving end 2, if the tail value carried is lost, it should be regarded as a data loss.

It should also be understood that the first receiving end information referred to in the present disclosure means that the data has been received and the feedback has been given through the head. Therefore, the receiving end information may reflect the quantity of data actually received by the receiving end and the number of head values that have been fed back by the receiving end for this receiving, which is different from the reported head value.

Specifically, by comparing the values of tx_tail_cache and tx_head cache, the transmitting end 1 may determine whether to initiate a retransmission of data. For example, in the example shown in FIG. 8, the transmitting end 1 finds that it has transmitted 5 pieces of data (the value of tx_tail_cache is equal to 5). However, the receiving end 2 only receives 3 pieces of data (the value of tx_head_cache is equal to 3), so the transmitting end 1 may confirm that the interruption signal reported by the communication link is due to the data loss or error.

According to an embodiment of the present disclosure, determining whether to retransmit the data according to the type of the interruption includes: determining the breakpoint of the interruption according to the second quantity if the type of the interruption is determined to be the data loss from the transmitting end to the receiving end; retransmitting the data from the breakpoint.

Further, as mentioned above, when the value of tx_head_cache changes to 3, the value of tx_tail_ckpt is updated to 3 accordingly, so that transmitting end 1 may know that 3 pieces of data have been transmitted successfully, and the retransmission should start with the fourth data. It should be understood that the breakpoint of the interruption described above, which is determined based on the second quantity, is essentially determined based on the breakpoint position determined by the second quantity. The tx_tail_ckpt may identify the breakpoint position.

Next, as shown in FIG. 8, after the data is determined to be retransmitted, the data begins to be retransmitted. At this point, the state 4 and state 3 remain the same.

Next, when the data [4,5] is retransmitted successfully, the value of rx tail cache of the receiving end 2 is updated from 3 to 5, which indicates that the receiving end 2 has successfully received the data [4,5], as shown in a state 4′ in FIG. 8.

After receiving the data [4,5], the receiving end 2 will feedback a head signal to the transmitting end. Therefore, the value of rx_head_cache is updated from 3 to 5, as shown in a state 5′. As mentioned above, the rx_head_cache indicates rx_head that has been transmitted by the receiving end 2 but has not yet acknowledged as received by the transmitting end 1. Generally speaking, the transmitting of the rx_head does not require additional acknowledgement from the receiving end 1, as long as no timeout occurs, it is considered to have been delivered.

In addition, as shown in the state 5′ in FIG. 8, the value of rx_head_ckpt is also updated to 5, which indicates that the receiving end 2 has received an acknowledgement from the transmitting end 1 after transmitting a head signal to the transmitting end 1.

Further, at the transmitting end 1, the value of tx_head_cache is updated according to the value of rx head_cache fed back by the receiving end 2. Thus, the value of tx_head_cache is updated to 5. Accordingly, the value of tx_tail_ckpt is also updated to 5, as shown in a state 5 in FIG. 8. In this case, the value of tx_tail_cache is the same as the value of tx_head_cache, which indicates that the quantity of data transmitted by the transmitting end 1 is the same as that received by the receiving end 2, so there is no need to retransmit data.

According to an embodiment of the present disclosure, determining the type of the interruption according to the first transmitting end information and the first receiving end information includes: determining the type of the interruption as a response loss for the data that is fed back from the receiving end to the transmitting end if the first quantity equals the second quantity.

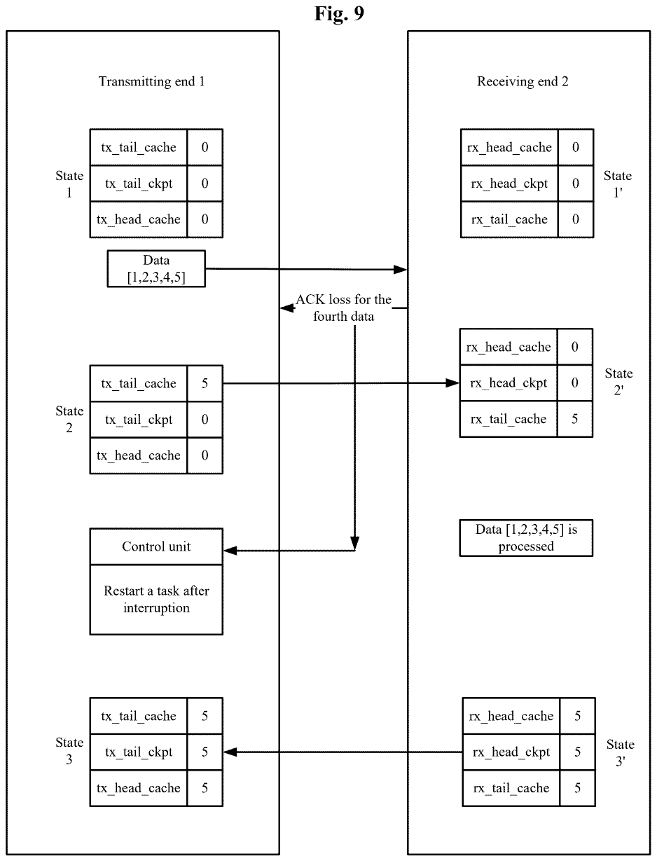

Specific circumstances of the above embodiment are described below in conjunction with FIG. 9. FIG. 9 shows a loss of ACK fed back from the receiving end 2. It should be understood that, for the sake of simplification, in FIG. 9, only the transmitting and receiving directions of data are shown, and the transmitting and receiving units are not shown.

As shown in FIG. 9, a first state table that records states of parameters may be stored at the transmitting end 1. The first state table may contain at least three parameters, for example, tx_tail_cache, tx_tail_ckpt, and tx_head_cache. In an initial state, values of these parameters are all 0, as shown in a state 1 in FIG. 9.

Similarly, a second state table that records states of parameters may be stored at the receiving end 2. The second state table may contain at least three parameters, for example, rx_head_cache, rx_head_ckpt, and rx_tail_cache. In an initial state, values of these parameters are all 0, as shown in a state 1′ in FIG. 9.

Next, assuming that the transmitting end 1 transmits 5 pieces of data to the receiving end 2, in other words, data [1,2,3,4,5], then the value of tx_tail_cache changes to 5, which indicates that the transmitting end 1 has transmitted 5 pieces of data, but whether the 5 pieces of data reach the receiving end 2 has not been acknowledged. When transmitting data, the transmitting end 1 also transmits the tail of each data to the receiving end. Each time a piece of data is transmitted, the tail value increments. This is as shown in a state 2 in FIG. 9.

At the receiving end 2, when data is received, the rx_tail_cache increases as the tail value increases. Unlike the embodiment shown in FIG. 8, in the embodiment of the present disclosure, all data [1,2,3,4,5] are successfully transmitted to the receiving end 2. Therefore, the value of rx_tail_cache is updated to 5. This is as shown in a state 2′ in FIG. 9.

After receiving the data [1,2,3,4,5], the receiving end 2 processes the data and transmits head information back to the transmitting end 1, but whether the transmitting end 1 receives the head value is unknown. Since only 5 pieces of data are received at the receiving end 2, the receiving end 2 transmits information with head ranging from 1 to 5. In this case, the state of rx_head_cache is updated to 5, which indicates that receiving end 2 has transmitted 5 pieces of head information (rx_head), but the 5 pieces of head information are not acknowledged as received by the transmitting end 1, as shown in a state 3′ in FIG. 9.

However, in the embodiment shown in FIG. 9, the (ACK) information of the fourth data packet is lost, in other words, the transmitting end 1 only receives 3 pieces of ACK information, but in fact all data packets have been received and processed at the receiving end 2.

After the receiving end 2 has processed the data, the rx_head_cache is updated to 5 and transmitted to the transmitting end 1. After the transmitting end 1 receives the head and transmits the feedback signal, the receiving end updates the rx_head_ckpt. As shown in the state 3′ in FIG. 9, the rx_head_ckpt is updated to 5.

Since the ACK information of data packets 4 and 5 is not received, the transmitting end 1 will trigger a timeout mechanism, and a control unit will restart the task. After the new task of the transmitting end 1 is started, the head value received from the receiving end 2 is checked, and the tx_head_cache is updated to 5, which indicates that after the transmitting end 1 has transmitted 5 pieces of data, the receiving end 2 confirms that it has received 5 pieces of data. Therefore, the transmitting end 1 confirms that its previous timeout is caused by the loss of ACK and may directly end without resending any data, as shown in a state 3 in FIG. 9.

Further, as shown in the state 3 in FIG. 9, the tx_head_ckpt is correspondingly updated to 5.

As shown above, the rx_head_ckpt in the state 3′ in FIG. 9 should be 5.

Therefore, according to an embodiment of the present disclosure, determining the type of the interruption according to the first transmitting end information and the first receiving end information includes: determining the type of the interruption as a response loss for the data that is fed back from the receiving end to the transmitting end if the first quantity equals the second quantity.

In this case, the value of tx_tail_cache is the same as the value of tx_head_cache, which indicates that the quantity of data transmitted by the transmitting end 1 is the same as that received by the receiving end 2, so the transmitting end 1 may be aware that the type of the interruption is a response loss for the data that is fed back from the receiving end to the transmitting end. According to an embodiment of the present disclosure, if the type of the interruption is determined as a response loss for the data that is fed back from the receiving end to the transmitting end, it is determined that there is no need for data retransmission.

According to an embodiment of the present disclosure, to-be-retransmitted data is stored through a cache area at the application layer. According to this embodiment, the transport layer does not require additional space for retransmission, and the application layer directly reuses the cache area (such as Recvbuffer) directly used by the application layer, which does not require additional space, thus saving the storage overhead of the transport layer.

According to an embodiment of the present disclosure, a retransmission instruction is transmitted through the application layer for retransmission of the data.

According to this embodiment, a data retransmission instruction may be provided at the application layer of the transmitting end. In this way, the retransmission at the application layer may correctly complete the link error situation and ensure data reliability through retransmission.

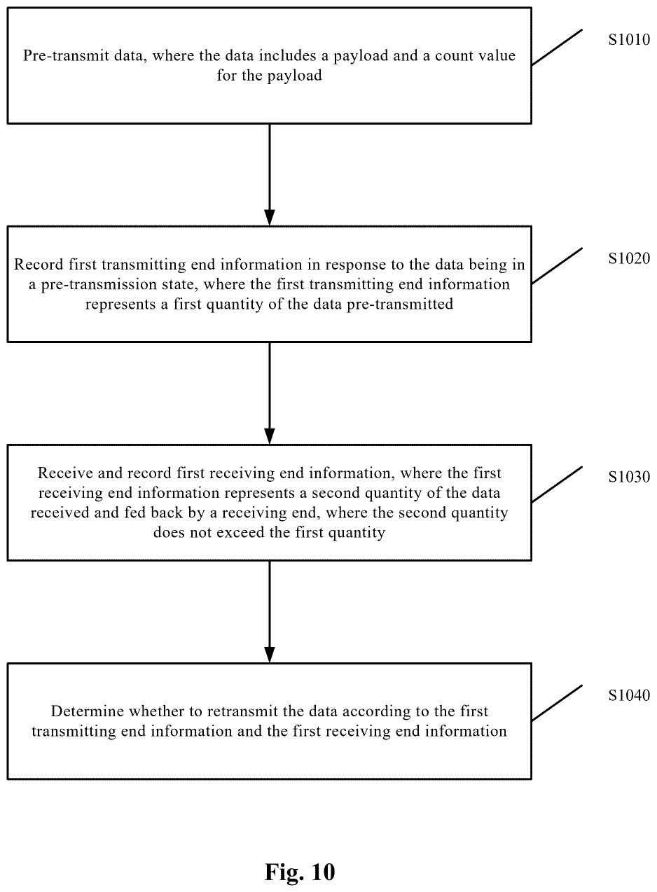

FIG. 10 shows a flowchart of a method for controlling data retransmission at an application layer according to another aspect of the present disclosure, including: in step S1010, pre-transmitting data, where the data includes a payload and a count value for the payload; in step S1020, recording first transmitting end information in response to the data being in a pre-transmission state, where the first transmitting end information represents a first quantity of the data pre-transmitted; in step S1030, receiving and recording first receiving end information, where the first receiving end information represents a second quantity of the data received and fed back by a receiving end, where the second quantity does not exceed the first quantity; and in step S1040, determining whether to retransmit the data according to the first transmitting end information and the first receiving end information.

FIG. 10 shows the operation performed by the transmitting end, which is described in conjunction with FIGS. 6-9 above and will not be repeated here.

According to an embodiment of the present disclosure, pre-transmitting the data includes: placing the data in a storage space at the transmitting end for transmission. The storage space refers to the underlying hardware storage space at the transmitting end.

According to an embodiment of the present disclosure, recording the first transmitting end information in response to the data being in the pre-transmission state includes: incrementing the first quantity accordingly in response to the increment of the data placed in the pre-transmission state, regardless of whether the data is successfully transmitted, and/or whether a response to the data is received.

According to an embodiment of the present disclosure, receiving and recording the first receiving end information includes: updating the second quantity as the first receiving end information changes.

According to an embodiment of the present disclosure, receiving and recording the first receiving end information includes: recording the second receiving end information with the largest second quantity.

According to an embodiment of the present disclosure, in response to an interruption signal reported from a communication link, whether to retransmit the data is determined according to the first transmitting end information and the first receiving end information.

According to an embodiment of the present disclosure, determining whether to retransmit the data according to the first transmitting end information and the first receiving end information includes: determining the type of the interruption according to the first transmitting end information and the first receiving end information; and determining whether to retransmit the data according to the type of the interruption.

According to an embodiment of the present disclosure, determining the type of the interruption according to the first transmitting end information and the first receiving end information includes: determining the type of the interruption as a data loss or error from the transmitting end to the receiving end if the first quantity is greater than the second quantity.

According to an embodiment of the present disclosure, the data loss or error from the transmitting end to the receiving end includes a loss or error of a payload, and/or a loss or error of a count value.

According to an embodiment of the present disclosure, determining whether to retransmit the data according to the type of the interruption includes: determining the breakpoint of the interruption according to the second quantity if the type of the interruption is determined to be the data loss from the transmitting end to the receiving end; retransmitting the data starting from the breakpoint.

According to an embodiment of the present disclosure, determining the type of the interruption according to the first transmitting end information and the first receiving end information includes: determining the type of the interruption as a response loss for the data that is fed back from the receiving end to the transmitting end if the first quantity equals the second quantity.

According to an embodiment of the present disclosure, determining whether to retransmit the data according to the type of the interruption includes: determining that there is no need to retransmit the data if the type of the interruption is determined a response loss for the data that is fed back from the receiving end to the transmitting end.

According to an embodiment of the present disclosure, to-be-retransmitted data is stored through a cache area (such as Recvbuffer) at the application layer.

According to an embodiment of the present disclosure, a retransmission instruction is transmitted through the application layer for retransmission of the data.

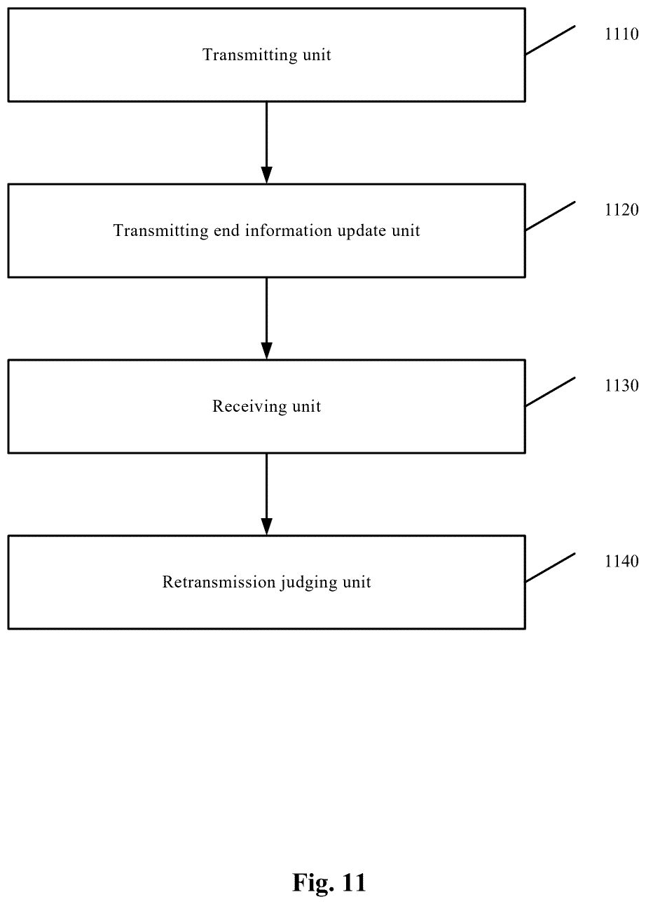

FIG. 11 shows a device configured to control data retransmission at an application layer according to an aspect of the present disclosure, including: a transmitting unit 1110 configured to pre-transmit data, where the data includes a payload and a count value for the payload; a transmitting end information update unit 1120 configured to record first transmitting end information in response to the data being in a pre-transmission state, where the first transmitting end information represents a first quantity of the data pre-transmitted; a receiving unit 1130 configured to receive and record first receiving end information, where the first receiving end information represents a second quantity of the data received and fed back by a receiving end, where the second quantity does not exceed the first quantity; and a retransmission judging unit 1140 configured to determine whether to retransmit the data according to the first transmitting end information and the first receiving end information.

An aspect of the present disclosure provides a communication system configured to control data retransmission at an application layer, where the communication system includes: a transmitting end, a receiving end, and a communication link connecting the transmitting end and the receiving end, where the transmitting end pre-transmits data to the receiving end, where the data includes a payload and a count value for the payload; the transmitting end records first transmitting end information in response to the data being in a pre-transmission state, where the first transmitting end information represents a first quantity of the data pre-transmitted; the communication link is configured to transmit the data; the receiving end records the count value if the data is received; the receiving end generates a second quantity according to the count value, where the second quantity represents the quantity of the data received and fed back by the receiving end; the receiving end feeds back the first receiving end information to the transmitting end, where the first receiving end information includes the second quantity, and the second quantity does not exceed the first quantity; the transmitting end receives and records the first receiving end information; and the transmitting end determines whether to retransmit the data according to the first transmitting end information and the first receiving end information.

Another aspect of the present disclosure further provides an electronic device. The electronic device includes: one or a plurality of processors; and a memory, on which a computer-executable instruction is stored, where when the computer-executable instruction is run by the one or the plurality of processors, the electronic device performs the above-mentioned method.

Another aspect of the present disclosure further provides a computer-readable storage medium, including a computer-executable instruction, where when the computer-executable instruction is run by one or a plurality of processors, the above-mentioned method is performed.

The present disclosure is based on the communication flow of head, tail and Data and the corresponding apparatus, and uses the relative relationship of Head/Tail to perform retransmission at the application layer, ensuring the reliability of communication.

At the same time, compared with the retransmission performed at the existing transport layer, the beneficial effects of data retransmission at the application layer are as follows.

In the present disclosure, the starting point and ending point of data may be known through the information of the application layer. Therefore, the communication protocol no longer needs to maintain the starting point and ending point that need to be retransmitted. It only needs to faithfully execute each transmission request issued by the application layer.

In addition, the transport layer does not require additional space for retransmission, and the application layer directly reuses the cache area (such as Recvbuffer) directly used by the application layer, which does not require additional space.

In the present disclosure, retransmission is performed by the application layer, and the application layer explicitly senses the occurrence of retransmission. In this way, when retransmission is performed at the application layer, the same task is not transmitted normally simultaneously. This prevents retransmission traffic from competing with normal task traffic on the link at the same time, thus reducing link congestion and packet loss probability.

According to the technical solution of the present disclosure, retransmission design at the software level at the application layer may reduce the hardware design of the transport layer, so the development is fast and the hardware customization cost is low.

According to different application scenarios, an electronic device or apparatus of the present disclosure may include a server, a cloud server, a server cluster, a data processing apparatus, a robot, a computer, a printer, a scanner, a tablet, a smart terminal, a PC device, an Internet of Things terminal, a mobile terminal, a mobile phone, a traffic recorder, a navigator, a sensor, a webcam, a camera, a video camera, a projector, a watch, a headphone, a mobile storage, a wearable device, a visual terminal, an autonomous driving terminal, a vehicle, a household appliance, and/or a medical device. The vehicle includes an airplane, a ship, and/or a car; the household appliance includes a television, an air conditioner, a microwave oven, a refrigerator, an electric rice cooker, a humidifier, a washing machine, an electric lamp, a gas cooker, and a range hood; and the medical device includes a nuclear magnetic resonance spectrometer, a B-ultrasonic scanner, and/or an electrocardiogramalectronic device or apparatus of the present disclosure may be further applied to Internet, Internet of Things, data center, energy, transportation, public management, manufacturing, education, power grid, telecommunications, finance, retail, construction sites, medical, and other fields. Further, the electronic device or apparatus of the present disclosure may be further used in application scenarios including cloud, edge, and terminal related to artificial intelligence, big data, and/or cloud computing. In one or a plurality of embodiments, according to the solution of the present disclosure, an electronic device or apparatus with high computing power may be applied to a cloud device (such as the cloud server), while an electronic device or apparatus with low power consumption may be applied to a terminal device and/or an edge device (such as a smart phone or the webcam). In one or a plurality of embodiments, hardware information of the cloud device is compatible with that of the terminal device and/or the edge device. As such, according to hardware information of the terminal device and/or the edge device, appropriate hardware resources may be matched from hardware resources of the cloud device to simulate hardware resources of the terminal device and/or the edge device, so as to complete unified management, scheduling, and collaborative work of terminal-cloud integration or cloud-edge-terminal integration.

The embodiments of the present disclosure have been described in detail above. Specific examples have been used in the specification to explain principles and implementations of the present disclosure. The descriptions of the embodiments above are only used to facilitate understanding of the method and core ideas of the present disclosure. Simultaneously, those skilled in the art may change or transform the specific implementation and application scope of the present disclosure according to the ideas of the present disclosure. The changes and transformations shall all fall within the protection scope of the present disclosure. In summary, the content of this specification should not be construed as a limitation on the present disclosure.

Through following articles, the technical solution of the present disclosure may be better understood.

Article 1. A method for controlling data retransmission at an application layer, including:
pre-transmitting data, where the data includes a payload and a count value for the payload; recording first transmitting end information in response to the data being in a pre-transmission state, where the first transmitting end information represents a first quantity of the data pre-transmitted;
receiving and recording first receiving end information, where the first receiving end information represents a second quantity of the data received and fed back by a receiving end, where the second quantity does not exceed the first quantity; and determining whether to retransmit the data according to the first transmitting end information and the first receiving end information.

Article 2. The method of article 1, where pre-transmitting the data includes: placing the data in a storage space at a transmitting end for transmission.

Article 3. The method of article 1 or 2, where recording the first transmitting end information in response to the data being in the pre-transmission state includes:

incrementing the first quantity accordingly in response to the increment of the data placed in the pre-transmission state, regardless of whether the data is successfully transmitted, and/or whether a response to the data is received.

Article 4. The method of any one of articles 1-3, where receiving and recording the first receiving end information includes: updating the second quantity as the first receiving end information changes.

Article 5. The method of any one of articles 1-3, where receiving and recording the first receiving end information includes: recording second receiving end information with the largest second quantity.

Article 6. The method of any one of articles 1-5, where whether to retransmit the data is determined according to the first transmitting end information and the first receiving end information in response to an interruption signal reported from a communication link.

Article 7. The method of article 6, where determining whether to retransmit the data according to the first transmitting end information and the first receiving end information includes: determining a type of an interruption according to the first transmitting end information and the first receiving end information; and determining whether to retransmit the data according to the type of the interruption.

Article 8. The method of article 7, where determining the type of the interruption according to the first transmitting end information and the first receiving end information includes: determining the type of the interruption as a data loss or error from the transmitting end to the receiving end if the first quantity is greater than the second quantity.

Article 9. The method of article 8, where the data loss or error from the transmitting end to the receiving end includes a loss or error of the payload, and/or a loss or error of the count value.

Article 10. The method of article 8 or 9, where determining whether to retransmit the data according to the type of the interruption includes:
determining a breakpoint of the interruption according to the second quantity if the type of the interruption is determined as the data loss from the transmitting end to the receiving end; and retransmitting the data starting from the breakpoint.

Article 11. The method of article 7, where determining the type of the interruption according to the first transmitting end information and the first receiving end information includes: determining the type of the interruption as a response loss for the data that is fed back from a receiving end to a transmitting end if the first quantity equals the second quantity.

Article 12. The method of article 11, where determining whether to retransmit the data according to the type of the interruption includes:
determining that there is no need to retransmit the data the if the type of the interruption is determined as the response loss for the data that is fed back from the receiving end to the transmitting end.

Article 13. The method of any one of articles 1-12, where to-be-retransmitted data is stored in a cache area at the application layer.

Article 14. The method of any one of articles 1-13, where a retransmission instruction is transmitted through the application layer for retransmission of the data.

Article 15. A device configured to control data retransmission at an application layer, including:
a transmitting unit configured to pre-transmit data, where the data includes a payload and a count value for the payload;
a transmitting end information update unit configured to record first transmitting end information in response to the data being in a pre-transmission state, where the first transmitting end information represents a first quantity of the data pre-transmitted;
a receiving unit configured to receive and record first receiving end information, where the first receiving end information represents a second quantity of the data received and fed back by a receiving end, where the second quantity does not exceed the first quantity; and
a retransmission judging unit configured to determine whether to retransmit the data according to the first transmitting end information and the first receiving end information.

Article 16. A method for controlling data retransmission at an application layer in a communication system, where the communication system includes: a transmitting end, a receiving end, and a communication link connecting the transmitting end and the receiving end, and the method includes:
at the transmitting end,
pre-transmitting data to the receiving end, where the data includes a payload and a count value for the payload;
recording first transmitting end information in response to the data being in a pre-transmission state, where the first transmitting end information represents a first quantity of the data pre-transmitted;
transmitting the data through the communication link;
at the receiving end,
recording the count value if the data is received;
generating a second quantity according to the count value, where the second quantity represents the quantity of the data received and fed back by the receiving end;
feeding back first receiving end information to the transmitting end, where the first receiving end information includes the second quantity, and the second quantity does not exceed the first quantity;
at the transmitting end,
receiving and recording the first receiving end information; and
determining whether to retransmit the data according to the first transmitting end information and the first receiving end information.

Article 17. The method of article 16, where pre-transmitting the data to the receiving end includes: placing the data in a storage space at the transmitting end for transmission.

Article 18. The method of article 16 or 17, where recording the first transmitting end information in response to the data being in the pre-transmission state includes:
incrementing the first quantity accordingly in response to the increment of the data placed in the pre-transmission state, regardless of whether the data is successfully transmitted, and/or whether a response to the data is received.

Article 19. The method of any one of articles 16-18, where recording the count value if the data is received includes: overwriting an old count value with a new count value.

Article 20. The method of any one of articles 16-18, where recording the count value if the data is received includes:
searching for a maximum count value in the received data; and recording the maximum count value only.

Article 21. The method of any one of articles 16-20, where receiving and recording the first receiving end information includes: updating the second quantity as the first receiving end information changes.

Article 22. The method of any one of articles 16-20, where receiving and recording the first receiving end information includes: recording second receiving end information with the largest second quantity.

Article 23. The method of any one of articles 16-22, where the communication link reports an interruption signal to the transmitting end in response to the occurrence of a specific event.

Article 24. The method of article 23, where the communication link reports the interruption signal to the transmitting end in response to a data loss or error from the transmitting end to the receiving end.

Article 25. The method of article 24, where the data loss or error from the transmitting end to the receiving end includes a loss or error of the payload, and/or a loss or error of the count value.

Article 26. The method of article 23, where the communication link reports the interruption signal to the transmitting end in response to a response loss for the data that is fed back from the receiving end to the transmitting end.

Article 27. The method of any one of articles 16-26, where whether to retransmit the data is determined according to the first transmitting end information and the first receiving end information in response to the interruption signal reported from the communication link.

Article 28. The method of article 27, where determining whether to retransmit the data according to the first transmitting end information and the first receiving end information includes:
determining a type of an interruption according to the first transmitting end information and the first receiving end information; and determining whether to retransmit the data according to the type of the interruption.

Article 29. The method of article 28, where determining the type of the interruption according to the first transmitting end information and the first receiving end information includes: determining the type of the interruption as the data loss or error from the transmitting end to the receiving end if the first quantity is greater than the second quantity.

Article 30. The method of article 29, where determining whether to retransmit the data according to the type of the interruption includes:
determining a breakpoint of the interruption according to the second quantity if the type of the interruption is determined as the data loss from the transmitting end to the receiving end; and retransmitting the data starting from the breakpoint.

Article 31. The method of article 28, where determining the type of the interruption according to the first transmitting end information and the first receiving end information includes: determining the type of the interruption as the response loss for the data that is fed back from the receiving end to the transmitting end if the first quantity equals the second quantity.

Article 32. The method of article 31, where determining whether to retransmit the data according to the type of the interruption includes:
determining that there is no need to retransmit the data the if the type of the interruption is determined as the response loss for the data that is fed back from the receiving end to the transmitting end.

Article 33. The method of any one of articles 16-32, where to-be-retransmitted data is stored in a cache area at the application layer.

Article 34. The method of any one of articles 16-33, where a retransmission instruction is transmitted through the application layer for retransmission of the data.

Article 35. A communication system configured to control data retransmission at an application layer, where the communication system includes: a transmitting end, a receiving end, and a communication link connecting the transmitting end and the receiving end, where
the transmitting end pre-transmits data to the receiving end, where the data includes a payload and a count value for the payload;
the transmitting end records first transmitting end information in response to the data being in a pre-transmission state, where the first transmitting end information represents a first quantity of the data pre-transmitted;
the communication link is configured to transmit the data;
the receiving end records the count value if the data is received;
the receiving end generates a second quantity according to the count value, where the second quantity represents the quantity of the data received and fed back by the receiving end;
the receiving end feeds back first receiving end information to the transmitting end, where the first receiving end information includes the second quantity, and the second quantity does not exceed the first quantity;
the transmitting end receives and records the first receiving end information;
the transmitting end determines whether to retransmit the data according to the first transmitting end information and the first receiving end information.

Article 36. An electronic device, including:
one or a plurality of processors; and
a memory, on which a computer-executable instruction is stored, where when the computer-executable instruction is run by the one or the plurality of processors, the electronic device performs the method of any one of articles 1-14 or articles 16-34

Article 37. A computer-readable storage medium, including a computer-executable instruction, where when the computer-executable instruction is run by one or a plurality of processors, the method of any one of articles 1-14 or articles 16-34 is performed.

1. A method for controlling data retransmission at an application layer, comprising:
pre-transmitting data, wherein the data comprises a payload and a count value for the payload;
recording first transmitting end information in response to the data being in a pre-transmission state, wherein the first transmitting end information represents a first quantity of the data pre-transmitted;
receiving and recording first receiving end information, wherein the first receiving end information represents a second quantity of the data received and fed back by a receiving end, wherein the second quantity does not exceed the first quantity; and
determining whether to retransmit the data according to the first transmitting end information and the first receiving end information.

2. The method of claim 1, wherein pre-transmitting the data comprises: placing the data in a storage space at a transmitting end for transmission.

3. The method of claim 1, wherein recording the first transmitting end information in response to the data being in the pre-transmission state comprises:
incrementing the first quantity accordingly in response to the increment of the data placed in the pre-transmission state, regardless of whether the data is successfully transmitted, and/or whether a response to the data is received.

4. The method of claim 1, wherein receiving and recording the first receiving end information comprises: updating the second quantity as the first receiving end information changes.

5. The method of claim 1, wherein receiving and recording the first receiving end information comprises: recording second receiving end information with the largest second quantity.

6. The method of claim 1, wherein whether to retransmit the data is determined according to the first transmitting end information and the first receiving end information in response to an interruption signal reported from a communication link.

7. The method of claim 6, wherein determining whether to retransmit the data according to the first transmitting end information and the first receiving end information comprises:
determining a type of an interruption according to the first transmitting end information and the first receiving end information; and
determining whether to retransmit the data according to the type of the interruption.

8. The method of claim 7, wherein determining the type of the interruption according to the first transmitting end information and the first receiving end information comprises:
determining the type of the interruption as a data loss or error from a transmitting end to the receiving end if the first quantity is greater than the second quantity.

9. The method of claim 8, wherein the data loss or error from the transmitting end to the receiving end comprises a loss or error of the payload, and/or a loss or error of the count value.

10. The method of claim 8, wherein determining whether to retransmit the data according to the type of the interruption comprises:
determining a breakpoint of the interruption according to the second quantity if the type of the interruption is determined as the data loss from the transmitting end to the receiving end; and
retransmitting the data starting from the breakpoint.

11. The method of claim 7, wherein determining the type of the interruption according to the first transmitting end information and the first receiving end information comprises:
determining the type of the interruption as a response loss for the data that is fed back from a receiving end to a transmitting end if the first quantity equals the second quantity.

12. The method of claim 11, wherein determining whether to retransmit the data according to the type of the interruption comprises:
determining that there is no need to retransmit the data the if the type of the interruption is determined as the response loss for the data that is fed back from the receiving end to the transmitting end.

13. The method of claim 1, wherein to-be-retransmitted data is stored in a cache area at the application layer.

14. The method of claim 1, wherein a retransmission instruction is transmitted through the application layer for retransmission of the data.

15. A device configured to control data retransmission at an application layer, comprising:
a transmitting unit configured to pre-transmit data, wherein the data comprises a payload and a count value for the payload;
a transmitting end information update unit configured to record first transmitting end information in response to the data being in a pre-transmission state, wherein the first transmitting end information represents a first quantity of the data pre-transmitted;
a receiving unit configured to receive and record first receiving end information, wherein the first receiving end information represents a second quantity of the data received and fed back by a receiving end, wherein the second quantity does not exceed the first quantity; and
a retransmission judging unit configured to determine whether to retransmit the data according to the first transmitting end information and the first receiving end information.

16-35. (canceled)

36. An electronic device, comprising:
one or a plurality of processors; and
a memory, on which a computer-executable instruction is stored, wherein when the computer-executable instruction is run by the one or the plurality of processors, the electronic device performs the method of claim 1.

37. A computer-readable storage medium, comprising a computer-executable instruction, wherein when the computer-executable instruction is run by one or a plurality of processors, the method of claim 1 is performed.

38. The method of claim 2, wherein recording the first transmitting end information in response to the data being in the pre-transmission state comprises:
incrementing the first quantity accordingly in response to the increment of the data placed in the pre-transmission state, regardless of whether the data is successfully transmitted, and/or whether a response to the data is received.

39. The method of claim 2, wherein whether to retransmit the data is determined according to the first transmitting end information and the first receiving end information in response to an interruption signal reported from a communication link.

40. The method of claim 9, wherein determining whether to retransmit the data according to the type of the interruption comprises:
determining a breakpoint of the interruption according to the second quantity if the type of the interruption is determined as the data loss from the transmitting end to the receiving end; and
retransmitting the data starting from the breakpoint.
